(19) United States
(12) Patent Application Publication
(10) Pub. No.: US 2019/0002333 A1
(43) Pub. Date: Jan. 3, 2019

(54) METHOD AND DEVICE FOR CUTTING GLASS TUBES

(71) Applicant: SCHOTT AG, Mainz (DE)

(72) Inventor: Franz Völkl, Friedenfels (DE)

(73) Assignee: SCHOTT AG, Mainz (DE)

(21) Appl. No.: 16/020,537

(22) Filed: Jun. 27, 2018

(30) Foreign Application Priority Data
Jun. 28, 2017 (DE) 102017210942.4

(51) Int. Cl. C03B 33/06; G01N 21/896

(52) U.S. Cl. CPC C03B 33/06; B65G 2201/0276; G01N 21/896

(57) ABSTRACT

The present disclosure relates to a method and device for cutting glass tubes with a length L from a glass tubing that moves at a feed rate v₁. The glass tubing is investigated for defects with an analytical device. The analytical device determines whether a glass tube to be separated is either defect-free (case 1) or contains defects (case 2). In case 1, a defect-free glass tube of the length L is separated from the glass tubing. In case 2, the device and method of the present disclosure determines a distance L_{A} in the lengthwise direction between the defect and a free end of the glass tube to be separated. The distance L_{A} is determined from the portion of the defect at the greatest distance from the free end of the tube. The device and method of the present disclosure then separates a piece of a glass tube or a glass tube that contains defects from the glass tubing at a distance L_{S} from the free end of the glass tube, as a function of L_{A}.

### CROSS-REFERENCE TO RELATED APPLICATIONS

The present application claims the benefit of German Patent Application No. DE 10 2017 210 942.4, filed on Jun. 28, 2017, which is herein incorporated by reference.

### BACKGROUND OF THE DISCLOSURE

### 1. Field of the Disclosure

The present disclosure relates to a method and a device for cutting glass tubes having a length L from a glass tubing that moves at a feed rate v₁.

### 2. Description of the Related Art

For cutting glass tubes of a specific length, which can be further processed subsequently as blanks, a refined glass melt is first made into the form of tubing by means of a forming tool. This is conducted, for example, by the Danner method or by the Vello method. An endless glass tubing that moves at a usually continuous feed rate is provided by these methods. Glass tubes with a length L, which is predetermined relative to the final product, are cut from this glass tubing. The speed of the subsequent processing lines results from the separation cycle or tempo, which in turn results from the quotient of the feed rate v₁ and the length L of the glass tube.

The separation of the glass tube from the glass tubing (also “detaching”) is produced by way of local scoring of the surface of the glass tubing, whereby a predetermined breaking site is produced, and subsequently, the glass tubing is mechanically loaded at its free end, whereupon the glass tube breaks from the rest of the glass tubing at the predetermined breaking site. The mechanical loading is applied by the gravitational force of the free end of the glass tubing, which is not supported for this reason. In order to improve the quality of the break, the glass tubing can be cooled at the predetermined breaking site, in order to initiate a spontaneous break at this site, i.e., a break by thermal shock, as is known, for example, from the document JP 2007-331994 A. On the side of the glass tubing, the site of separation then forms the free end of the following glass tube to be separated.

For reasons of quality assurance, the glass tubing can be investigated for defects, so that glass tubes that have a defect can be sorted out. Included in said defects are, in particular, blisters (i.e., air inclusions), scratches, streaks and discolorations.

A drawing method for the manufacture of cylinder-shaped components of quartz glass is known from DE 10 2009 014 418 B3. The components are cut from a continuous quartz glass tubing. Diameter fluctuations of the components may occur in the separation of the components from the quartz glass tubing due to the mechanical effects necessary therefor. The disclosed method does not then serve for reducing these fluctuations. Rather, the fluctuations are positioned in favorable regions of the quartz glass tubing so that they can be eliminated, for example, by the further processing of the components.

U.S. Pat. No. 3,205,740 describes the processing of glass panes or panels manufactured from a continuous glass strip. Provided for this are, sequentially, a so-called Z cutter and an S cutter, which subdivide the glass strip first crosswise to the flow direction and subsequently perpendicular thereto. Several analytical devices are found in front of the two cutting directions, and by means of said analytical devices, it is determined where in the glass strip the defects are found. The object of the method is to separate as many large glass panes as possible that are free of defects from the flat glass strip, wherein these glass panes have different sizes.

A device is known from JP 2008-81342 A for sorting out defective glass tubes, said device having a guide element, with which detached glass tubes are deflected onto a transport device if they have been recognized to be free of defects, and into a reject container if they have been recognized to contain defects. According to this process, a glass tube is thus first separated from the glass tubing, and subsequently it is considered whether or not a defect is found in said glass tube. In this way, either a complete, defect-free glass tube is supplied for further processing, or a complete, defect-containing glass tube is disposed of. A not inconsiderable number of rejects arise thereby in the known methods. These rejects, of course, can be recycled, but in this case, energy must be expended in order to re-melt the glass.

Therefore, it is the object of the present disclosure to reduce rejects when cutting glass tubes from a glass tubing, in order to decrease the total energy requirement and to reduce the material usage in glass tube manufacture.

### SUMMARY OF THE DISCLOSURE

In one embodiment, the present disclosure provides a method for cutting glass tubes having a length L from a glass tubing that moves at a feed rate v₁. The method comprises the steps of: investigating the glass tubing with an analytical device; and determining whether a glass tube of length L to be separated from the glass tubing is either defect-free (case 1) or contains defects (case 2). In case 1, the method further comprises separating the glass tube of the length L from the glass tubing. In case 2, the method further comprises a) determining a distance L_{A} in the lengthwise direction between the defect and a free end of the glass tube to be separated, wherein the distance L_{A} is determined from the portion of the defect at the greatest distance from the free end of the tube; and b) separating a piece of a glass tube or a glass tube that contains defects from the glass tubing at a distance L_{S} from the free end of the glass tube as a function of L_{A}.

In another embodiment, the present disclosure provides a device for cutting glass tubes with a length L from a glass tubing that moves at a feed rate v₁. The device comprises: an analytical device for investigating the glass tubing for defects; a separating apparatus for separating glass tubes and glass tube pieces from the glass tubing; and a transport device for removal of the separated glass tubes. The analytical device determines whether a glass tube to be separated from the glass tubing is either defect-free (case 1) or contains defects (case 2). In case 1, the analytical device emits a control signal that prompts the separating apparatus to separate a defect-free glass tube of length L from the glass tubing. In case 2, the analytical device determines a distance L_{A} in a lengthwise direction between where the defect is located and a free end of the glass tube to be separated, wherein the distance L_{A} is determined from the portion of the defect at the greatest distance from the free end of the tube, and the analytical device emits a control signal that prompts the separating apparatus to separate a defect-containing glass tube piece or glass tube from the glass tubing at a distance L_{S} from the free end of the glass tubing as a function of L_{A}.

In the method according to the present disclosure for cutting glass tubes having a length L from a glass tubing that moves at a feed rate v₁, the glass tubing is investigated for defects by means of an analytical device, wherein it is determined whether a glass tube to be separated is either defect-free (case 1) or contains defects (case 2). In case 1, a defect-free glass tube of the length L is separated from the glass tubing. The method according to the present disclosure is characterized in that the following steps are conducted in case 2:
a) determination of a distance L_{A} in the lengthwise direction between the defect and a free end of the glass tube to be separated, wherein the distance L_{A} is determined from that portion of the defect found at the greatest distance from the free end of the tube; and
b) separation of a piece of a glass tube or a glass tube that contains defects from the glass tubing at a distance L_{S} from the free end of the glass tube as a function of L_{A}.

In the known method, glass tubes of the length L are always separated, independent of whether a defect is found, which leads to the fact that glass tubes containing defects also always have the length L, whereby an unnecessarily large quantity of rejects accrues. By way of the method according to the present disclosure, for the first time, the position of the defect in the form of the distance L_{A} from the free end of the glass tube is determined and considered in the separation process. It is possible thereby to separate from the tubing the glass tube piece that contains a defect at a distance L_{S} that is not equal to L, preferably having a length L_{S}<L, if the distance L_{A} of the defect from the free end of the glass tube to be separated permits this. For the first time, the separation is made with control by the parameter L_{A}.

Advantageously, the distance L_{S} is selected so that it is greater than L_{A}, particularly by a predetermined Δ (L_{S}=L_{A}+A), which also requires that the distance L_{A} between the defect and the free end of the glass tube to be separated permits this.

It is important to note that here defects are usually not punctiform, but have an extent, particularly in the lengthwise direction of the glass tube. The portion of the defect at the greatest distance from the free end of the glass tube to be separated thus determines, taken precisely, the distance L_{A} between a defect and said free end of the tube.

For this reason, it is particularly not excluded that the defect also extends up to the distance L or L−A from the free end of the glass tube to be separated or even beyond this (L_{A}≥L or L_{A}+Δ≥L). In this case, in the method according to the present disclosure, a defect-containing glass tube of length L would also first be separated. Accordingly, preferably, L_{S}≤L would always apply. The “remainder” of the defect will then be separated in the next pass. L_{S} L thus takes precedence over L_{S}>L_{A} or L_{S}=L_{A}+A. The method according to the present disclosure always exploits its advantage when the defect is found at a distance L_{A}≤L or L_{A}+Δ≤L from the free end of the glass tube that is to be separated.

The feed rate v₁ is preferably constant.

There are various possibilities for investigating the glass tubing for defects. Advantageously, the investigation is conducted by an optical method, in particular a transmitted light method. The investigation of the glass tubing for defects is preferably conducted continuously.

In advantageous enhancements of the method according to the present disclosure, it is provided that the glass tubing is subdivided, starting from the free end of the glass tube to be separated, into n+1 segments A₁ to Aₙ₊₁ of identical length L/n with n=={2, 3, 4, . . . }, that according to step a) it is determined where, i.e., in which segment A_{D}={A₁, . . . , Aₙ} the defect lies, i.e., the site of the (greatest) distance L_{A}, and that the glass tubing is separated at a boundary between segment A_{D} and segment A_{D+1}={A₂, . . . , Aₙ₊₁}. In this way, the glass tube to be separated is subdivided into individual segments, wherein subsequently it is possible to take into consideration for these individual segments whether or not they contain defects. If, for example, a glass tube is subdivided into four segments A₁ to A₄ and a defect is found in segment A₂, then a glass tube piece is separated from the glass tubing at the boundary between the segments A₂ and A₃. In this way, only a glass tube piece of length L/2 arises as a reject and not a defect-containing glass tube of length L as in a comparable case with the known methods.

If defects are found in several segments, then preferably the numerically highest segment will be taken for the determination of the site of the separation operation. If, for example, in the above-named example, a defect is found in each of the segments A₂ and A₃, then the numerically highest segment A₃ will be taken, so that a glass tube piece is separated from the glass tubing between segments A₃ and A₄. The same thing applies in the case of a defect spanning several segments.

After the separation, the separating site again forms the free end of the glass tubing, and the numerically lowest segment remaining on the glass tubing forms the new segment A₁ for the next glass tube to be separated. The method according to the present disclosure is then carried out again for the next glass tube to be separated.

Particularly preferred, n=2. In this way, the glass tubing is subdivided into three segments A₁ to A₃ of identical length L/2, starting from the free end of the glass tube to be separated. The glass tube to be separated in this case is comprised of the segments A₁ and A₂.

Defect-free glass tubes are preferably transferred to a transport device after the separation. The defect-free glass tubes can be conveyed for further processing by means of the transport device. The transport device has a feed rate v₂. The feed rate v₂ is preferably constant. The glass tubes are regularly supplied for further processing thereby, which is facilitates the automation of further processing.

In advantageous enhancements, the transport device has a multiple number of compartments for glass tubes. A single glass tube can be arranged in each compartment, whereby a safer transport is made possible. Also, each glass tube can be allocated to a specific compartment, so that the glass tubes can be clearly localized.

Advantageously, the compartments are formed by carriers arranged on a conveyor belt. The carriers are preferably formed by angle strips or sheet-metal profiles or removal pins, between which or in which the glass tubes come to lie during transport.

The length L of the glass tube typically amounts to between 1 m and 3 m. The feed rate v₁ preferably amounts to between 5 m/min and 600 m/min. The feed rate v₁ is usually dependent on the geometry and design of the tub in which the glass melt is found, the forming tool, and the glass tube being manufactured.

Basically, the separation of defect-containing glass tube pieces leads to the circumstance that the supply of defect-free glass tubes is irregular, since defects usually occur at irregular distances. In order to partially compensate for this irregularity of supply in any case, and thus to be able to synchronize the further processing with the cutting, according to an advantageous embodiment of the present disclosure, the feed rate v₂ and the division of the compartments is selected so that detached, defect-free glass tubes directly following one another are transferred into each n^{th} compartment of the transport device. If the feed rate v₁ of the glass tubing is constant, then the separating operation takes place during the movement of the glass tubing. After the separating operation, the separated glass tube maintains its momentum and travels along a curved path to the transport device, and, in particular, into a compartment of the transport device. If one wants to allocate a defect-free glass tube in a targeted manner to each n^{th} compartment, the feed rate v₂ of the transport device must therefore be synchronized with the feed rate v₁ of the glass tubing. More precisely, the separating tempo must be one n^{th} part of the feed tempo for the compartments. The feed tempo is formed from the quotient of the feed rate v₂ and the distance between the compartments. Additional parameters that enter into the synchronization are thus the length L of the glass tube and the division of the compartments or the distance between them. Now if the feed rate v₂ is selected so that during “regular operation”, i.e., when there is no defect present in the case of multiple glass tubes following one behind the other, a glass tube is arranged in every n^{th} compartment; i.e., between the compartments containing glass tubes, n−1 compartments of the transport device are empty in each case. The particular advantage of this enhancement consists in the fact that even after one or more defect-containing glass tube pieces of the length L/n, 2L/n, 3L/n, . . . , have been separated, the next defect-free glass tube is again allocated exactly to a compartment. Therefore, regularity is re-established and the further processing can be synchronized thereupon.

If, for example, for n=3, the glass tubing is separated at the boundary between the segments A₁ and A₂ due to a defect and thus the segment A₁ is discarded as a reject, this leads to the fact that compartment 3 (in general n), in which the next defect-free glass tube would be found if it had no defect, remains empty, and the now actually defect-free next glass tube is arranged in the immediately following compartment 4 (n+1). Instead of two compartments, now there are three compartments (1, 2, 3) in sequence that are empty in the transport device. An additional control of the transport device or of the feed rate v₂ can be dispensed with, since by establishing the segments and the compartments, any variation in the separating of glass tubes and glass tube pieces is possible, so that each defect-free glass tube lands in a compartment and not between two compartments.

An alternative solution for synchronization with subsequent further processing provides that separated, defect-free glass tubes are intermediately stored or buffered and subsequently regularly removed. The regular removal of the defect-free glass tubes from the intermediate storage or buffering preferably takes place at a frequency that is less than the regular separation tempo by which defect-free glass tubes would have been separated if no defects were present in the glass tubing. In other words, the difference in the frequencies of the separation tempo and the removal tempo balances out the waiting times caused by the separating of defect-containing glass tube pieces.

The separating of the glass tube from the glass tubing takes place, as is known, by local scoring of the surface of the glass tubing and subsequently mechanical loading of the free end of the glass tubing by gravitational force. A defect-containing glass tube piece to be separated, whose length is shorter than the length L of the glass tube experiences a smaller torque or bending moment due to a shorter lever arm and its lower weight. It is desirable, however, that even shorter defect-containing glass tube pieces display the same breaking behavior as defect-free, longer glass tubes. In advantageous enhancements of the method according to the present disclosure, it is therefore provided that when separating a glass tube piece with a length L_{S}<L, a force F_{U} that supports the gravitational force is exercised on the glass tube piece to be separated. Due to the additional force F_{U}, the same breaking behavior is produced at the separating site that is present when a glass tube of length L is separated.

Preferably, the supporting force F_{U} at least corresponds to the difference between a weight force F_{R} of a defect-free glass tube of length L and a weight force F_{S} of the separated glass tube piece (F_{U}≥F_{R}−F_{S}). Also, the force F_{U} and the point of attack thereof are preferably selected so that the breaking behavior corresponds to the breaking behavior that is present when separating a glass tube. In particular, the force F_{U} and the point of attack thereof are selected so that the moments or torque arising at the separating site correspond to those that are present when separating a glass tube of length L. An additional torque or bending moment M_{U} referred to the separating site preferably corresponds at least to the difference between the torque or bending moment M_{R} caused by a glass tube of length L and the torque or bending moment Ms caused by the glass tube piece.

After separating, the defect-containing glass tubes and glass tube pieces are preferably transferred to a collecting container. The defect-containing glass tubes and glass tube pieces can subsequently be conveyed from the collecting container to recycling.

The device according to the present disclosure for cutting glass tubes having a length L from a glass tubing moving at a feed rate v₁ comprises an analytical device for investigating the glass tubing for defects, a separating apparatus for separating glass tubes and glass tube pieces from the glass tubing, and a transport device for removing the separated glass tubes. The device is characterized in that it is designed for conducting the above-described method. This is realized in that the analytical device is equipped to determine whether a glass tube to be separated is either defect-free (case 1) or contains defects (case 2). The analytical device is further equipped to emit for case 1 a control signal that prompts the separating apparatus to separate a defect-free glass tube of length L from the glass tubing. And for case 2, the analytical device is equipped to determine the distance L_{A} in the lengthwise direction between the free end of the glass tube to be separated and the defect, and to emit a control signal that prompts the separating apparatus to separate a defect-containing glass tube piece or glass tube from the glass tubing at a distance L_{S} from the free end of the glass tube as a function of L_{A}.

Preferably, the device comprises a collecting container for defect-containing glass tubes and glass tube pieces. A collecting container makes possible an efficient collection of glass tubes and glass tube pieces with defects, so that these can be conveyed subsequently to recycling.

Advantageously, the device has a sorting apparatus, by means of which the defect-containing glass tubes and glass tube pieces are transferred to the collecting container, and defect-free glass tubes are conveyed to the transport device. The sorting apparatus thereby makes possible an automated sorting of defect-free glass tubes from defect-containing glass tubes and glass tube pieces.

As described above, the transport device preferably has a multiple number of compartments with a specific spacing (division) and is equipped to operate at a feed rate matched to the separation tempo, wherein detached, defect-free glass tubes directly following one another are transferred into each n^{th} compartment of the transport device. At the same time, the analytical device is advantageously equipped in case 2 to arithmetically subdivide the glass tubing into n+1 segments A₁ to Aₙ₊₁ of identical length L/n with n={2, 3, 4, . . . }, starting from the free end of the glass tube to be separated, to determine where, i.e., in which of these segments A_{D}={A₁, . . . , Aₙ} the defect lies, and to emit a control signal that prompts the separating apparatus to separate the glass tubing at the boundary between segment A_{D} and segment A_{D+1}={A₂, . . . , Aₙ₊₁}. In this combination, for the case of typically irregularly occurring defects, a regularity of removal of defect-free glass tubes is also ensured, and further processing can be synchronized thereupon.

In order to alternatively make possible an intermediate storage (buffering) of the defect-free glass tubes, the device advantageously has a buffering apparatus between the separating apparatus, or, if provided, the sorting apparatus, and the transport device, said buffering apparatus being equipped to regularly or irregularly take up defect-free glass tubes that have been separated from the glass tubing by the separating apparatus and to deliver the defect-free glass tubes regularly to the transport device. In this case, the glass tubes are particularly conveyed irregularly when defect-containing glass tubes or glass tube pieces have been separated in the meantime and have been discarded as rejects. The removal operation from the buffering apparatus is produced regularly, which is advantageous with respect to further processing.

Preferably, the separating apparatus has a breaking force booster that is equipped to exercise a force F_{U} that boosts the gravitational force on a glass tube to be separated having a length L_{S}<L. As described above, preferably the same breaking behavior is produced by the breaking force booster as would exist in the case of a glass tube of length L.

Particularly preferred, the breaking force booster has a cam element and/or an adjustable compressed air cylinder and/or a rotating arm, which is equipped to press from above onto the glass tube to be separated, directly or by means of a pressure piece. In addition, the force F_{U} is preferably applied with servo control. The force F_{U} as well as the time point of the action can be precisely controlled by means of servo-controlled equipment. In addition, an action of the breaking force booster is avoided thereby in the case of a defect-free glass tube.

### BRIEF DESCRIPTION OF THE DRAWINGS

FIG. 1 shows a device for cutting glass tubes according to a first embodiment.

FIG. 2 shows a device for cutting glass tubes according to a second embodiment.

FIG. 3 shows a device for cutting glass tubes according to a third embodiment.

FIG. 4 shows a device for cutting glass tubes according to a fourth embodiment.

FIG. 5 shows an end region of a glass tubing.

### DETAILED DESCRIPTION OF THE DRAWINGS

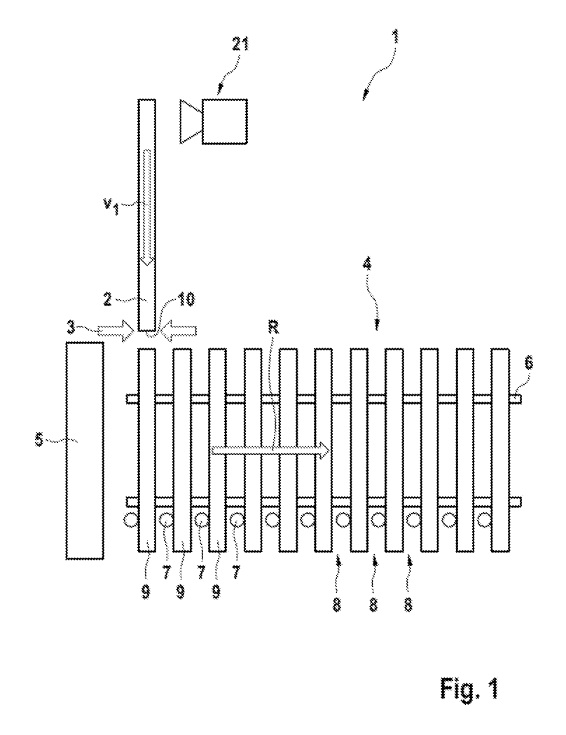

FIG. 1 shows a device 1 for cutting glass tubes from a glass tubing 2. The glass tubing 2 is transported in the direction of the arrow at a continuous feed rate v₁. The device 1 has an analytical device 21, a separating apparatus 3, which is symbolized by two arrows, a transport device 4, as well as a collecting container 5. The transport device 4 has a conveyor belt 6 on which carriers 7 are arranged. The carriers 7 form compartments 8, whereby a compartment 8 is formed between every two carriers 7.

According to the present disclosure, the glass tubing 2 is investigated for defects by means of the analytical device 21, wherein it is established, at least for the next glass tube 9 to be separated, whether it is free of defects or contains defects. If the glass tube 9 to be separated is defect-free, then it is separated from the glass tubing 2 by means of the separating apparatus 3. After the separation, the separated glass tube 9 moves further based on the feed rate v₁ of the glass tubing 2, so that it reaches a free compartment 8, which is kept ready, in the transport device 4. Subsequently, the conveyor belt 6 of the transport device 4 is moved in the direction of feed R, so that a new, free compartment 8 becomes available for the next defect-free glass tube 9.

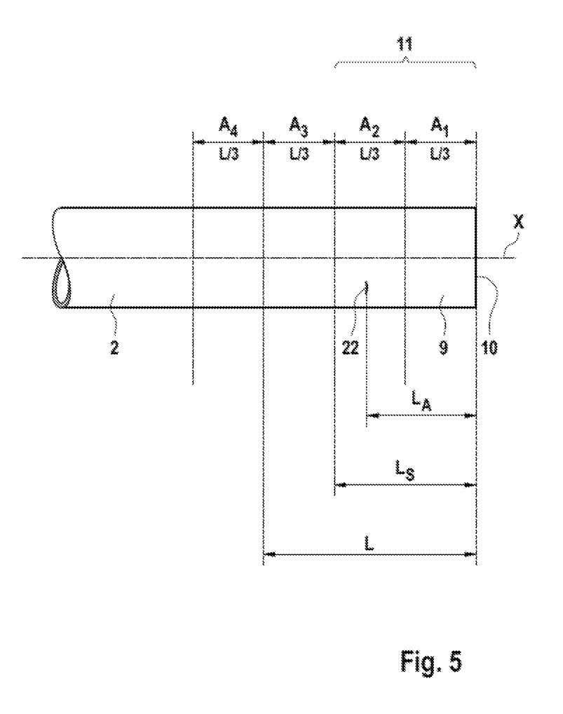

If it is established that the glass tube 9 to be separated contains defects, then a distance L_{A} is determined of how far the defect is from the free end 10 of the glass tubing 2 (see FIG. 5). Subsequently, the glass tubing 2 is separated at a site at a distance L_{S} from the free end of the glass tube, depending on L_{A}. Either a defect-containing glass tube 9 of length L or a defect-containing glass tube piece of length L_{S}<L is formed thereby. After being separated from the glass tubing 2, defect-containing glass tubes 9 and glass tube pieces are transferred to the collecting container 5. This can be achieved, for example, by way of a sorting apparatus, which is not shown.

While the defect-containing glass tube or glass tube piece is being separated and sorted out, the transport device 4 is at a standstill until the next defect-free glass tube 9 has been delivered to the next free compartment 8. In this way, in the case of the embodiment shown in FIG. 1, each compartment 8 of the transport device 4 is filled with a glass tube 9. At the same time, however a providing of defect-free glass tubes 9 to a device for the further processing of said glass tubes 9 is produced irregularly over time by the transport device 4, said further processing device connecting thereto, but not shown.

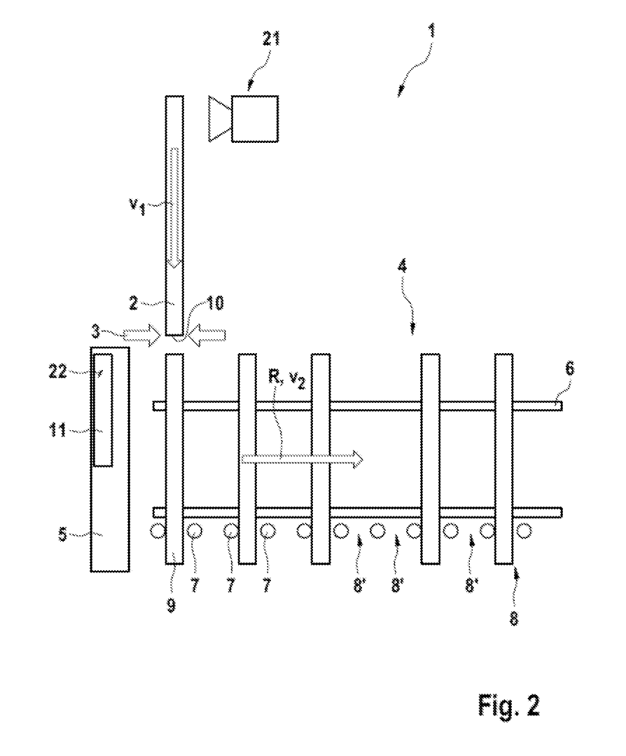

Shown in FIG. 2, the embodiment of the device 1 for cutting glass tubes 9 from a glass tubing 2 also comprises an analytical device 21, a separating apparatus 3, a transport device 4, and a collecting container 5. The glass tubing 2 again has a continuous feed rate v₁. The transport device 4 here also has a conveyor belt 6 with carriers 7. In this embodiment, the conveyor belt 6 moves continuously in a feed direction R at a feed rate v₂. The feed rate v₂ is determined such that when a plurality of defect-free glass tubes 9 are produced sequentially one after the other, one glass tube 9 is arranged in every second compartment 8. In this case, a single empty compartment 8′ is present between two compartments 8, in each of which a glass tube 9 is found.

According to the present disclosure, the glass tubing 2 is here also continuously investigated for defects 22. It is determined for each glass tube 9 to be separated whether the glass tube 9 is free of defects or contains defects. A defect-free glass tube 9 is separated from the glass tubing 2 by way of the separating apparatus 3, and automatically falls into a compartment 8 of the transport device 4, the fall brought about by the feed rate v₁. In the case of a defect-containing glass tube 9, the region of the glass tube 9 in which the defect 22 is found is determined. For this purpose, the glass tubing, starting from the free end 10 of the glass tube 9 to be separated is subdivided into a multiple number of segments (in the case of the embodiment shown in FIG. 2, into three segments, n=2) and subsequently, the segment(s) in which the defect 22 is arranged is/are determined. In the present case, the glass tube 9 to be separated is composed of two segments A₁, A₂. It is now determined whether the defect 22 is found in segment A₁ or in segment A₂.

If the defect 22 is found in segment A₁, then the glass tubing 2 is separated at the boundary between segments A₁ and A₂, so that a defect-containing glass tube piece 11 is formed. The glass tube piece 11 is then conveyed to the collecting container 5 by a sorting apparatus, which is not shown in this figure. Since the conveyor belt 6 of the transport device 4 continuously moves in the feed direction R, an additional empty compartment 8′ arises. If, directly afterward, a defect-free glass tube 9 is cut from the glass tubing 2, then two empty compartments 8′ are found between the latter and the previous defect-free glass tube 9.

If, for a defect-containing glass tube 9, it is determined that the defect 22 is arranged in segment A₂, then a complete, but defect-containing glass tube 9 of length L is separated and transferred to the collecting container 5 by the sorting apparatus.

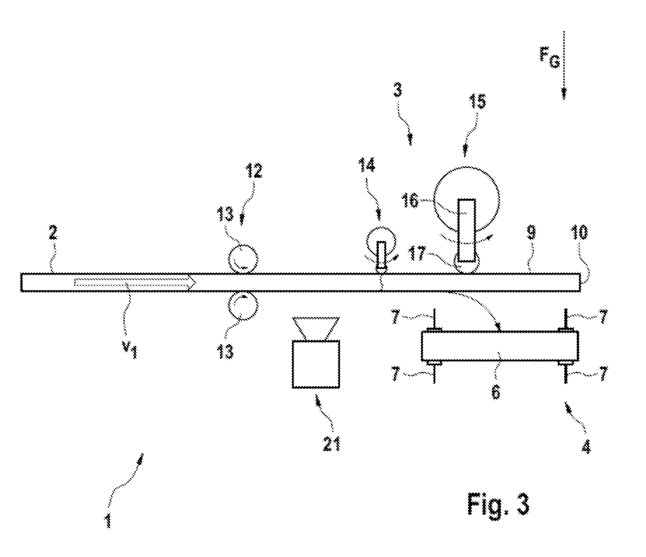

FIG. 3 schematically shows a device 1 for cutting glass tubes 9 from a glass tubing 2, in a lateral view. The glass tubing 2 is moved in the direction of the arrow at the continuous feed rate v₁ by means of a feed apparatus 12. The feed apparatus 12 has for this purpose two or more drawing rollers 13 or other suitable feed systems such as drawing chains or belts, which draw the glass tubing 2 from the hot forming operation connected upstream (not shown) and support the tubing at the same time.

The device 1 has an analytical device 21, a separating apparatus 3, as well as a transport device 4. The separating apparatus 3 has a scoring unit 14 and a breaking force booster 15. The glass tubing 2 is scored at the desired separating site by means of the scoring unit 14. The initial crack in this case is usually produced with diamond tools and preferably on the upper side of the glass tube, i.e., at the 12:00 o'clock position. In this way, microcracks are produced in the glass tube. Since the glass tubing 2 is not supported against gravitational force F_{G} in the region of the free end 10, a bending moment arises due to the tube weight that is present, and this leads to the broadening of the crack. An encircling crack arises along which the tube breaks. Water supports the process by temperature shock and penetration into the crack. The glass tube 9 is thus separated from the glass tubing 2 and subsequently the cut glass tube 9 can be delivered to the transport device 4 and conveyed to further processing. The transport device 4 here also has a conveyor belt 6 with carriers 7.

The breaking force booster 15 is preferably applied exclusively for separating glass tube pieces 11. Glass tube pieces 11 have a shorter length than glass tubes 9 and thus also have a lower weight. Without the breaking force booster 15, it may happen that a cracked glass tube piece 11 is not separated from the glass tubing 2 or has a deviating breaking behavior. Thanks to the breaking force booster 15, a force that supports the gravitational force F_{G} is exercised on a glass tube piece 11, so that the latter is separated from the glass tubing 2 and has the same breaking behavior as a complete glass tube 9. The breaking force booster 15 has for this purpose a rotating arm 16 that presses on the glass tube piece 11 to be separated, preferably from the top, by means of a pressure piece 17.

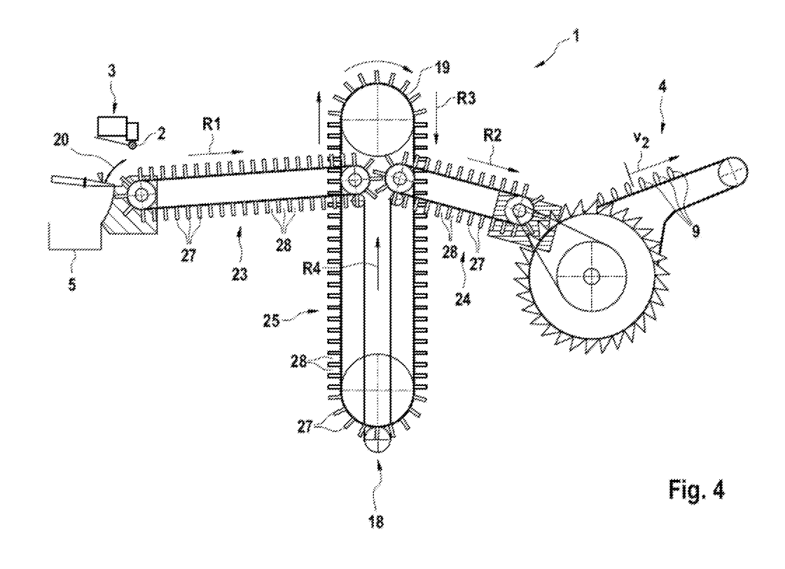

The fourth embodiment of the device 1 for cutting glass tubes 9 from a glass tubing 2, which is shown in FIG. 4, has a separating apparatus 3, a transport device 4 and a buffering apparatus 18 arranged between the separating apparatus 3 and the transport device 4. The glass tubing 2 again has a continuous feed rate v₁, so that defect-free glass tubes 9 are irregularly cut due to rejects that arise. The transport device 4 has a continuous feed rate v₂.

In order to equilibrate the irregular supply of glass tubes 9 from the separating apparatus 3 and the regular removal operation of the glass tubes 9 by the transport device 4, the buffering apparatus 18 is provided, which has a conveyor belt 23, a conveyor belt 24, and an intermediate storage unit 19 having a third conveyor belt 25. Each conveyor belt 23, 24, 25 has a multiple number of carriers 27, between which are formed compartments 28. A single glass tube 9 can be arranged in each compartment 28. Along an axis arranged perpendicular to the plane of the drawing, the carriers 27 of the first conveyor belt 23 and of the second conveyor belt 24 are each offset relative to the carriers 27 of the third conveyor belt 25, so that the carriers 27 of different conveyor belts 23, 24, 25 do not come into contact with one another during a movement of one or more of conveyor belts 23, 24, 25.

The first conveyor belt 23 transports defect-free glass tubes 9, which have been separated from the glass tubing 2 by means of the separating apparatus 3, along a feed direction R1 to the intermediate storage unit 19 by way of a conveyor belt 25. The second conveyor belt 24 transports glass tubes 9 from the intermediate storage unit 19 along a feed direction R2 to the transport device 4, by means of which the glass tubes 9 are supplied for further processing. The third conveyor belt 25 moves along a feed direction R3. In order to equilibrate the deviation between supply and removal, the intermediate storage unit can be moved along an equilibration direction R4.

The conveyor belt 25 is mounted in a floating manner for this purpose and is joined to an internal chain system. The chain from belt 23 and the left half of the chain from conveyor belt 25 are linked and run at the same speed. The chain from belt 24 and the right half of the chain from conveyor belt 25 are linked and also run at the same speed. If the speed of conveyor belt 23 is slower than that of conveyor belt 24, then the entire module 25 moves downward; the left side thus takes up fewer tubes than the right side delivers. A “storage reduction” occurs. In this case, the transfer positions of conveyor belt 23 on 25 and 25 on 24 remain at the same site. In contrast, the entire module 25 moves upward, if conveyor belt 23 runs faster than conveyor belt 24. A “storage increase” occurs.

In standard function when mostly all tubes are good, conveyor belt 23 and conveyor belt 24 run at the same speed. If a defect-containing glass tube 9 is separated and discarded, the first conveyor belt 23 does not move until the next good tube is delivered. This storage reduction can continue until the storage unit has reached a lower minimum position. If the storage unit is emptied, the belt 24 must run faster for a short time when a defect-containing glass tube 9 is separated and rejected, or temporarily run at twice the speed if a good tube is separated. The storage of tubes is increased in this way.

The frequency of the removal operation is selected so that it is less than the frequency with which defect-free glass tubes 9 would be cut at the glass tubing 2, if no defects were present. The difference in the frequencies of the supply and the removal balances out the waiting times that are caused by the separation of defect-containing glass tube pieces during production.

The device 1 also has a sorting apparatus 20, by means of which defect-containing glass tubes 9 are sorted out and conveyed to a collecting container 5. The sorting apparatus or “defective tube sluice” has an electrically or pneumatically driven flap, which is placed by pivoting between the tube segment to be separated and the conveyor belt for good tubes when a defect-containing glass tube is determined by means of the analytical device, and the defect-containing glass tube is steered to the collecting container 5.

FIG. 5 schematically shows the end region of a glass tubing 2 with the free end 10. The glass tubing 2 has a principal axis X about which the glass tubing 2 is rotationally symmetrical. The separating site at the axial distance L from the free end 10 of the glass tubing 2 where the defect-free glass tube 9 would be separated is plotted as a dotted guide line. The glass tubing 2 is further subdivided (n=3) into four segments A₁, A₂, A₃ and A₄ along the principal axis X, starting from the free end 10. The segments A₁, A₂, A₃, A₄ each have a uniform length of L/3. The separating site at the distance L thus coincides with the boundary between segments A₃ and A₄, or stated another way, the glass tube 9 to be separated is composed of the segments A₁, A₂, A₃.

The glass tubing 2 or the glass tube 9 to be separated has a defect 22. The defect 22 has a distance L_{A}, measured in the lengthwise direction, from the free end 10 of the glass tubing 2 and is found in the segment A₂. Taking into consideration the position of the defect 22 or the distance L_{A}, the glass tubing 2 is separated according to the present disclosure at the boundary between the segments A₂ and A₃, whereby a glass tube piece 11 of length ⅔×L is formed. The segment A₃ then forms the new segment A₁ for the next glass tube 9 to be separated. In this example, when compared to the known methods in which an entire glass tube of length L would be separated and discarded, the reject is reduced by ⅓ L.

Statistically, the defect is found with the same probability in each of the three segments A₁ to A₃, if one disregards overlapping defects, so that the rejects can also be reduced overall approximately by ⅓ L to ⅔ L (=⅓×(⅓ L+⅔ L+1 L)). With an increase of n, i.e., the number of segments, the rejects are further reduced; of course, the reduction cannot go below ½ L for statistical reasons.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

### LIST OF REFERENCE CHARACTERS

1 Device
2 Glass tubing
3 Separating apparatus
4 Transport device
5 Collecting container
6 Conveyor belt
7 Carrier
8 Compartment
8′ Empty compartment
9 Glass tube
10 Free end
11 Glass tube piece
12 Feed apparatus
13 Drawing rollers
14 Scoring unit
15 Breaking force booster
16 Rotating arm
17 Pressure piece
18 Buffering apparatus
19 Intermediate storage unit
20 Sorting apparatus
21 Analytical device
22 Defect
23 First conveyor belt
24 Second conveyor belt
25 Third conveyor belt
27 Carrier
28 Compartment
A₁ to A₄ Segment
F_{G} Gravitational force
L Length
R Feed direction
R1 Feed direction
R2 Feed direction
R3 Feed direction
R4 Equilibration direction
v₁ Feed rate
v₂ Feed rate
X Principal axis

What is claimed is:

1. A method for cutting glass tubes having a length L from a glass tubing that moves at a feed rate v₁, comprising the steps of:
investigating the glass tubing with an analytical device;
determining whether a glass tube of length L to be separated from the glass tubing is either defect-free (case 1) or contains defects (case 2);
in case 1, separating the glass tube of the length L from the glass tubing; and
in case 2,
a) determining a distance L_{A} in the lengthwise direction between the defect and a free end of the glass tube to be separated, wherein the distance L_{A} is determined from the portion of the defect at the greatest distance from the free end of the tube; and
b) separating a piece of a glass tube or a glass tube that contains defects from the glass tubing at a distance L_{S} from the free end of the glass tube as a function of L_{A}.

2. The method of claim 1, further comprising the steps of:
subdividing the glass tubing, starting from the free end of the glass tube to be separated, into n+1 segments A₁ to Aₙ₊₁ of identical length L/n with n={2, 3, 4, . . . };
in case 2, determining a segment A_{D} in which the defect lies; and
separating the glass tubing at a boundary between segment A_{D} and segment A_{D+1}.

3. The method of claim 2, wherein n=2.

4. The method of claim 1, further comprising the step of delivering defect-free glass tubes to a transport device after separation.

5. The method of claim 4, wherein the transport device has a constant feed rate v₂.

6. The method of claim 5, wherein the transport device has a multiple number of compartments for glass tubes.

7. The method of claim 6, wherein the feed rate v₂ and the division of the compartments are selected so that successively cut, defect-free glass tubes are directly transferred into each compartment of the transport device.

8. The method of claim 1, further comprising the steps of:
buffering the separated, defect-free glass tubes; and
subsequently, removing the separated, defect-free glass tubes.

9. The method of claim 1, wherein when a glass tube piece with a length L_{S}<L is separated, a force F_{U} supporting a gravitational force F_{G} is exercised on the glass tube piece to be separated.

10. The method of claim 1, wherein defect-containing glass tubes and glass tube pieces are transferred into a collecting container after separation.

11. A device for cutting glass tubes with a length L from a glass tubing that moves at a feed rate v₁, comprising:
an analytical device for investigating the glass tubing for defects;
a separating apparatus for separating glass tubes and glass tube pieces from the glass tubing; and
a transport device for removal of the separated glass tubes,
wherein the analytical device determines whether a glass tube to be separated from the glass tubing is either defect-free (case 1) or contains defects (case 2),
wherein, in case 1, the analytical device emits a control signal that prompts the separating apparatus to separate a defect-free glass tube of length L from the glass tubing,
wherein, in case 2, the analytical device determines a distance L_{A} in a lengthwise direction between where the defect is located and a free end of the glass tube to be separated, wherein the distance L_{A} is determined from the portion of the defect at the greatest distance from the free end of the tube, and the analytical emits a control signal that prompts the separating apparatus to separate a defect-containing glass tube piece or glass tube from the glass tubing at a distance L_{S} from the free end of the glass tubing as a function of L_{A}.

12. The device according to claim 11, further comprising a collecting container for defect-containing glass tubes.

13. The device according to claim 12, further comprising a sorting apparatus to convey defect-containing glass tubes and glass tube pieces to the collecting container and to convey defect-free glass tubes to the transport device.

14. The device according to claim 11, further comprising, between the separating apparatus and the transport device, a buffering apparatus that takes up separated, defect-free glass tubes from the separating apparatus and to delivers them to the transport device.

15. The device according to claim 11, further comprising a breaking force booster that exercises a force F_{U} that boosts the gravitational force F_{G} on a glass tube piece to be separated, wherein the glass tube piece to be separate has a length L_{S}<L.

16. The device according to claim 15, wherein the breaking force booster comprises at least one of a cam element, a compressed air cylinder, and a rotating arm that is equipped to press on the glass tube piece to be separated, directly or with a pressure piece.
